(19) United States
(12) Patent Application Publication
(10) Pub. No.: US 2007/0002380 A1
(43) Pub. Date: Jan. 4, 2007

(54) Method and system for error compensation

(75) Inventors: David Jon Metcalfe, Marion, NY (US); Zhenhuan Wen, Rochester, NY (US); Robert Paul Robideau, Webster, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/171,936

(22) Filed: Jun. 30, 2005

(51) Int. Cl. H04N 1/40

(52) U.S. Cl. 358/3.03

(57) ABSTRACT

A method and system for performing error diffusion is disclosed. An error value for a pixel may be received and used to determine one or more error diffusion values. The error diffusion values may be determined by performing bit shifting of the error value. Truncation of the error diffusion values may result in a difference between the error value and a sum of the error diffusion values. This difference may be compensated for by adding error compensation values to the error diffusion values to yield compensated error diffusion values. The compensated error diffusion values may then be diffused to appropriate destination pixels.

### TECHNICAL FIELD

The disclosed embodiments generally relate to the field of image processing.

### BACKGROUND

Error diffusion methods, such as the method described in R. W. Floyd & L. Steinberg, “An Adaptive Algorithm for Spatial Grayscale,” in the Proceedings of the Society for Information Display, vol. 17, pp 75-77 (1976) (the “Floyd-Steinberg method”), are often used to convert grayscale images to binary images on a binary output device. Such error diffusion methods typically examine a pixel in an input image, determine whether the intensity for the pixel in the input image exceeds a threshold, and assign either a light or dark binary value to the pixel in an output image based on whether it exceeds the threshold. The difference between the input image pixel intensity and the corresponding pixel intensity in the output image is the error for the pixel. Error diffusion methods assign at least a portion of the error to each of one or more neighboring pixels that have not been previously assigned a pixel intensity for the output image. In this manner, the total pixel intensity is substantially maintained throughout the output image without a substantial loss of resolution. However, individual pixels might be lighter or darker in the resulting image than in the input image.

For example, FIG. 1A depicts grayscale values for neighboring pixels in an input image. Each pixel has a grayscale value within a range. In an computer embodiment having 8-bit color, a low value for the range is “0” and a high value for the range is “255.”

FIG. 1B depicts the resulting light/dark values for the four pixels based on a traditional error diffusion method. In FIG. 1B, the threshold for the light/dark determination is the midpoint of the range (i.e., a grayscale value of 127.5). Since the first pixel has a grayscale value greater than the threshold, the pixel is assigned a value of “1” (e.g., “light” or “white”). The difference between the original grayscale value for the first pixel and the resulting high value is defined to be the error value, E₁. In other words, the error is equal to the amount of compensation added to a pixel in order to force it to a “0” or “1” value.

For the second pixel, the error value E₁ is subtracted from the original value for the pixel. Since the resulting value is less than the threshold, the second pixel is assigned a value of “0” (e.g., “dark”). The error value, E₂, is computed for the second pixel. The process iterates over each subsequent pixel until all pixels are computed. Alternate error diffusion methods might diffuse the calculated error among a plurality of unconverted pixels. For example, a first portion of the error value E₁ for the first pixel could be subtracted from the second pixel and a second portion could be subtracted from the third pixel.

Exemplary methods of using error diffusion to generate an output image include the methods described in U.S. Pat. Nos. 5,226,094 and 5,374,997 to Eschbach, the disclosures of each of which are incorporated by reference in their entirety.

Within the last decade, error diffusion rendering techniques have enjoyed a wide range of image-quality enhancements. Recent advancements have extended the application of error diffusion algorithms into the color domain, offering excellent print quality across a number of reprographic engines and inkjet marking products in both hardware and software.

One problem inherent in the Floyd-Steinberg method, its progeny and other current error diffusion methods is that error determinations for pixels require a significant amount of computation when implemented in hardware. Propagation of the error due to pixel binarization requires fast and efficient use of hardware to provide the necessary high-speed throughput data rates needed to distribute the error to the destination pixels. The throughput or clock speed at which the error diffusion algorithm can be performed limits the number of pages which can be produced in a particular time frame.

As throughput requirements increase, the required error diffusion rates can become difficult or expensive to achieve with current implementations. This is particularly so when information is transferred in an environment in which trace lengths affect the maximum clock rate. Alternatively, processors that perform the computations at the required rates might not be cost effective for particular applications.

Alternate error diffusion methods, such as the one described in U.S. Pat. No. 5,353,127 to Shiau et al., the disclosure of which is incorporated herein by reference in its entirety, and for which methods are shown herein in FIG. 2, were developed to satisfy the speed requirements for hardware implementations. The error diffusion weights (the “Shiau-Fan” or “anti-worm” coefficients) shown in FIG. 2 may be generated using simple bit-shifting techniques. As such, this error diffusion method allows for faster calculations with limited circuitry.

Although the anti-worm coefficients permit efficiency and speed, the error caused by truncation due to bit-shifting may be significant at extreme light and dark intensities. In any error diffusion technique, all error must be maintained and propagated to the downstream pixels regardless of the source. If this “truncated” error is not fully accounted for, the true (desired) intensity levels are not precisely rendered.

What is needed is a multi-pixel error diffusion method that enables high-speed error diffusion for computing error diffusion and intensity information.

A need exists for reducing the cost of performing error diffusion for an image.

A need exists for an error diffusion method and system that compensate for truncation in error compensation.

A further need exists for an error diffusion system that is programmable based on the error diffusion method being performed and the resulting image quality.

The present disclosure is directed to solving one or more of the above-listed problems.

### SUMMARY

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to a “pixel” is a reference to one or more pixels and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. All publications mentioned herein are incorporated by reference. Nothing herein is to be construed as an admission that the embodiments described herein are not entitled to antedate such disclosure by virtue of prior invention.

In an embodiment, a method for performing error diffusion may include receiving an error value for a pixel, determining one or more error diffusion values based on the error value, compensating for a difference between the error value and a sum of the error diffusion values by summing each error diffusion value with a corresponding error compensation value to yield one or more compensated error diffusion values, and diffusing a compensated error diffusion value to a destination pixel.

In an embodiment, a system for performing error diffusion may include a processor, and a processor-readable storage medium in communication with the processor. The processor-readable storage medium may contain one or more programming instructions for performing a method for performing error diffusion including receiving an error value for a pixel from a memory location in the processor-readable storage medium pertaining to the pixel, determining, via the processor, one or more error diffusion values based on the error value, compensating, via the processor, for a difference between the error value and a sum of the error diffusion values by summing each error diffusion value with a corresponding error compensation value to yield one or more compensated error diffusion values, and diffusing a compensated error diffusion value to a memory location in the processor-readable storage medium pertaining to a destination pixel.

In an embodiment, a method for producing an output image by performing error diffusion in a xerographic apparatus may include receiving an input image including a plurality of pixels; determining a pixel intensity value for each pixel; for each pixel, receiving an initial error value, computing a pixel value for the pixel and an updated error value each computed based on the pixel intensity value for the pixel and the initial error value, determining one or more error diffusion values based on the updated error value, compensating for a difference between the updated error value and a sum of the error diffusion values by summing each error diffusion value with a corresponding error compensation value to yield a compensated error diffusion value, and diffusing a compensated error diffusion value to an initial error value for a destination pixel; and generating an output image based on the pixel values.

### BRIEF DESCRIPTION OF THE DRAWINGS

Aspects, features, benefits and advantages of the embodiments described herein will be apparent with regard to the following description, appended claims and accompanying drawings where:

FIG. 1A depicts grayscale levels for neighboring pixels.

FIG. 1B depicts the resulting pixel values using a traditional method of computing error diffusion.

FIG. 2 depicts the error-diffusion weights and the destination pixels for a traditional method of computing error diffusion.

FIG. 3 depicts an exemplary flow diagram for a method for performing error diffusion according to an embodiment.

FIG. 4 depicts a truncation error table for an exemplary error diffusion method according to an embodiment.

FIG. 5 depicts an exemplary hardware implementation of a truncation correction unit according to an embodiment.

FIG. 6 depicts an exemplary look-up table with values according to an embodiment.

FIG. 7 depicts an exemplary grayscale sweep for which no divisional bit-shifting truncation error compensation is performed.

FIG. 8 depicts an exemplary grayscale sweep for which divisional bit-shifting truncation error compensation is performed according to an embodiment.

FIG. 9 is a block diagram of exemplary internal hardware that may be used to contain or implement the program instructions according to an embodiment.

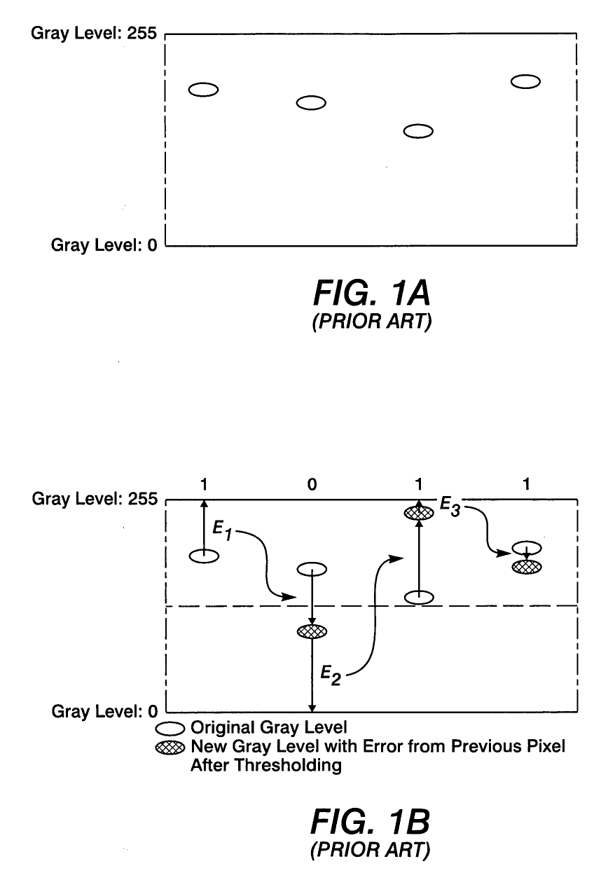

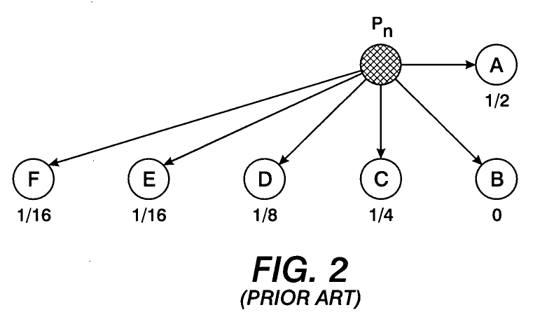

### DETAILED DESCRIPTION

In selected embodiments, a programmable device may retain a bit-shifted error component and properly distribute the error in a deterministic manner. As such, the gray levels may be recaptured, and an accurate rendered binary output may be generated. In an embodiment, a programmable look-up table (LUT), a register array, and/or the like may be used to detect and efficiently distribute the error component to the destination pixels.

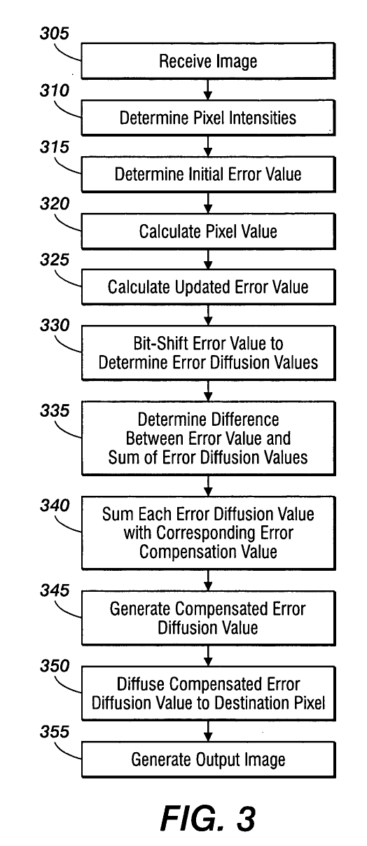

Referring to FIG. 3, in an embodiment, an image may be enhanced by a method for performing error diffusion by receiving an image 305, such as would occur through digital acquisition of an image by a xerographic apparatus, scanner, fax machine, camera or other digital image acquisition device. The image may include any number of pixels. The method may also include determining a pixel intensity value 310 and initial error value 315 for each pixel. In an embodiment, the pixel intensity value may be set to a grayscale value of the pixel in the image. In an alternate embodiment, the pixel intensity value may be set to one or more values based on the presence or absence of pre-determined colors for the pixel. Using the pixel intensity value and initial error value for a pixel, a pixel value 320 and an updated error value 325 may be calculated for the pixel. The method may include determining one or more error diffusion values based on the error value 330 through a suitable method, such as bit-shifting the initial error value; and compensating for a difference between the initial error value and a sum of the error diffusion values by adding an error compensation value to one or more of the error diffusion values 340. In an embodiment, compensating for the difference may include determining 335 the difference between the initial error value and a sum of the error diffusion values by a suitable method such as accessing a programmable LUT. The address of the LUT may be determined using one or more bits, such as a sign bit, of the initial error value. Each error diffusion value may be summed with a corresponding error compensation value to yield a compensated error diffusion value 345. The sum of the error compensation values may equal the difference between the initial error value and the sum of the error diffusion values. A compensated error diffusion value may be diffused to a destination pixel 350. Thus, an enhanced output image 355 may be generated using the error diffusion method.

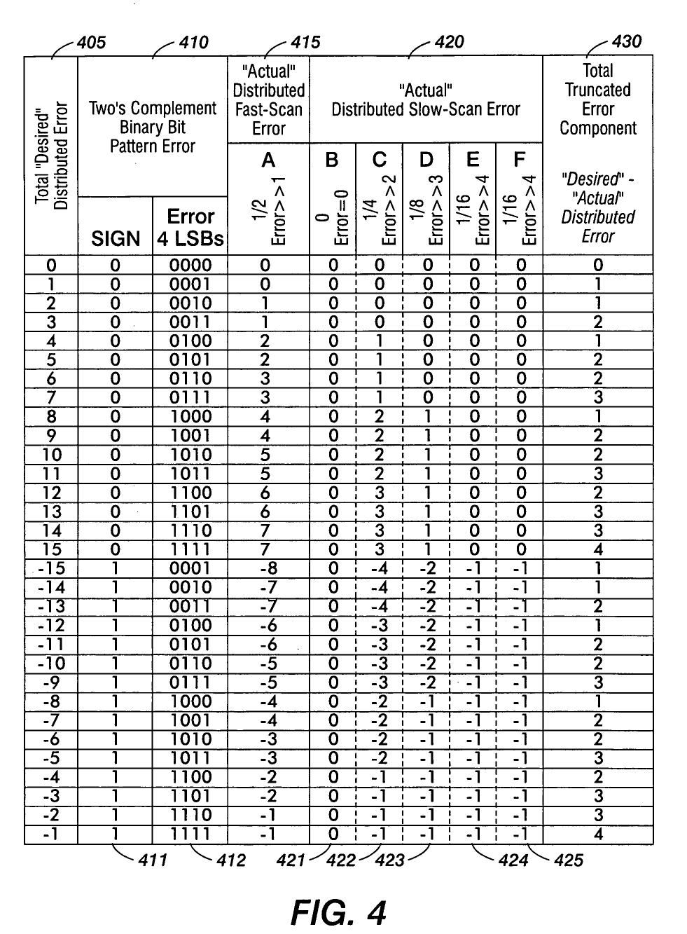

FIG. 4 depicts a truncation error table that further illustrates an exemplary error diffusion method according to an embodiment. As shown in FIG. 4, the truncation error table summarizes the truncation error that may be produced by a bit-shifting algorithm using, for example, the Shiau-Fan coefficients. In this example, only the four least-significant bits of the total distributed error may be considered since these bits are truncated when computing the 1/16^{th} coefficients for destination pixels “E” and “F.” The last column may represent the total error that should be distributed to the destination pixels, but is truncated due to bit-shifting. Although the maximum truncated error value may only be, for example, four gray levels (out of, for example, 256 gray levels), not capturing and properly distributing this truncated error value may result in a loss of image quality in the extreme highlight and shadow regions. The truncation error table and the values contained therein are merely exemplary and are not meant to be limiting. Additional, fewer and/or different columns, values, bits, least significant bits and the like may be used to model any of a plurality of error diffusion algorithms.

In FIG. 4, the total “desired” distributed error column 405 (i.e., the initial error value or the error value) may denote the decimal representation of the error that is intended to be diffused to the destination pixels. The 2's complement binary bit pattern error 410 may include a sign bit 411 and the four least significant error bits 412 which represent the total desired distributed error 405 in binary format. Additional or fewer error bits 412 may be included based on the error diffusion weights for a particular error diffusion method.

The “actual” distributed fast-scan error 415 may include the error diffusion value diffused to destination pixel A in the Shiau-Fan error diffusion method. Since the error diffused to destination pixel A 415 in the Shiau-Fan method is one-half of the error, each entry in the table may be equal to one-half of the total desired distributed error 405 (rounded). This value may be computed by bit shifting the four least significant error bits 412 by one and maintaining the sign 411. The fast-scan error 415 may be required to be computed in one cycle since destination pixel A may be the next pixel for which error is determined.

The “actual” distributed slow-scan error 420 may include the error diffusion values diffused to destination pixels B-F in the Shiau-Fan error diffusion method. According to the Shiau-Fan error diffusion method, the error diffusion values for destination pixel B 421, destination pixel C 422, destination pixel D 423, destination pixel E 424 and destination pixel F 425 may equal 0, one-quarter of the total desired distributed error 405, one-eighth of the total desired distributed error, one-sixteenth of the total desired distributed error, and one-sixteenth of the total desired distributed error (rounded), respectively. Each of the error diffusion values for destination pixels C-F may be computed by bit-shifting the four least significant error bits 412 by an appropriate amount and maintaining the sign 411. Additional or fewer destination pixels and/or different pixel weights may be utilized within the scope of this disclosure.

The entries in the total truncated error component column 430 may equal the total desired distribution error 405 minus the sum of the actual distributed fast-scan error 415 and the actual distributed slow-scan error 420. The total truncated error component 430 may represent the amount of error that is not properly diffused by bit shifting the error value.

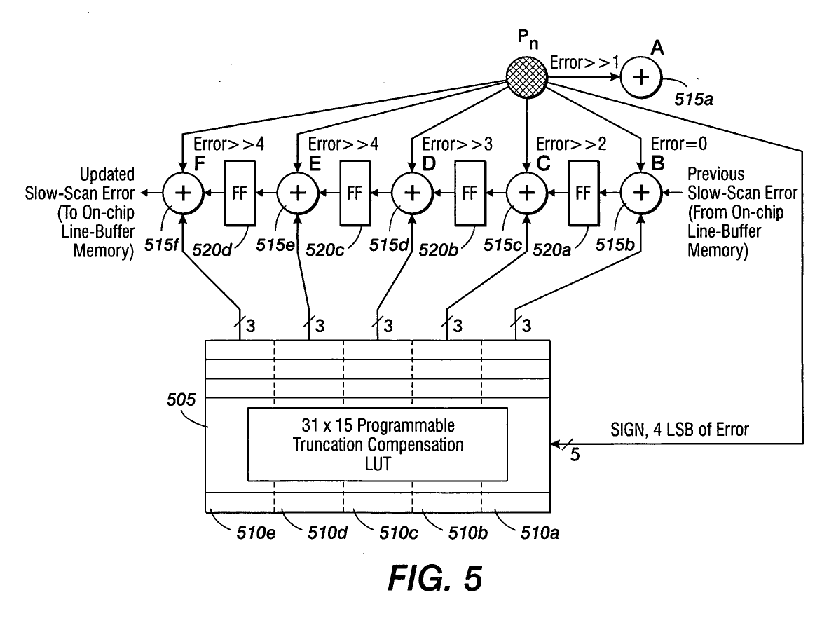

FIG. 5 depicts an exemplary hardware implementation of an error truncation compensation unit according to an embodiment. As shown in FIG. 5, the sign bit (411 in FIG. 4) and the four least significant bits (412 in FIG. 4) of the total desired distribution error (generated, for example, as a result of “binarization” via a conventional error diffusion process) may be used as the index/address for a programmable 31×15 error truncation compensation look-up table (LUT) 505. The LUT 505 may contain error compensation values. The LUT 505 may include fewer or more rows or columns depending upon the number of address bits and the amount of information to be transmitted by the LUT 505. As such, the dimensions of the LUT 505 shown in FIG. 5 are merely exemplary.

The 15-bit output may be partitioned into, for example, five sections 510a-e. For example, one 3-bit section may be input to each adder 515b-f in the slow-scan error distribution circuit. In this way, the truncated error may not only be adjusted to re-capture the lost gray level(s) via bit-shifting, but may also be distributed to result in the best image quality (i.e., fewer worming artifacts, etc.). In addition, since the architecture includes a programmable LUT 505, the error may be uniquely adjusted to take into account the “round-up” effect of bit-shifting binary numbers. As a result, the LUT 505 may produce symmetrical and nearly identical bit-patterns at both the extreme highlight (i.e., 254, 253, 252, etc.) and shadow (i.e., 1, 2, 3, etc.) regions.

The flip flops 520a-d may be used to transmit error truncation information from all pixels for which the particular pixel is a destination. For example, as pixel_{N} is examined, destination pixel B receives the sum of the error truncation compensation information 510a (i.e., an error compensation value) from the LUT 505 and the previous slow-scan error which may be stored in an on-chip line-buffer memory. This value (i.e., a compensated error diffusion value) may be stored in flip flop 520a. When pixel_{N+1} is examined, destination pixel C may be the same pixel as destination pixel B for pixel_{N}. Accordingly, the error value for the pixel may include the sum of the error from pixel_{N+1}>>2, flip flop 520a, and the error compensation information 510b (i.e., a second error compensation value) from the LUT 505. This value (i.e., a second compensated error diffusion value) may be stored in flip flop 520b. This process may be repeated until the output of adder 515f is stored in the line-buffer memory for the pixel. This error may later be retrieved when the pixel occupies the destination pixel A and pixel_{N} locations.

In an embodiment, the LUT 505 may be extended with an additional 3-bit partition that supplies additional error truncation information caused by the bit-shifted truncation to the adder for destination pixel A 515a in order to enhance an output image quality. However, any error transmitted to the adder for destination pixel A 515a must be transmitted in one clock cycle if processing one pixel per cycle is required. In an alternate embodiment, all truncated error may be captured and diffused to the slow-scan destination pixels. As a result, the original gray-level information may be maintained.

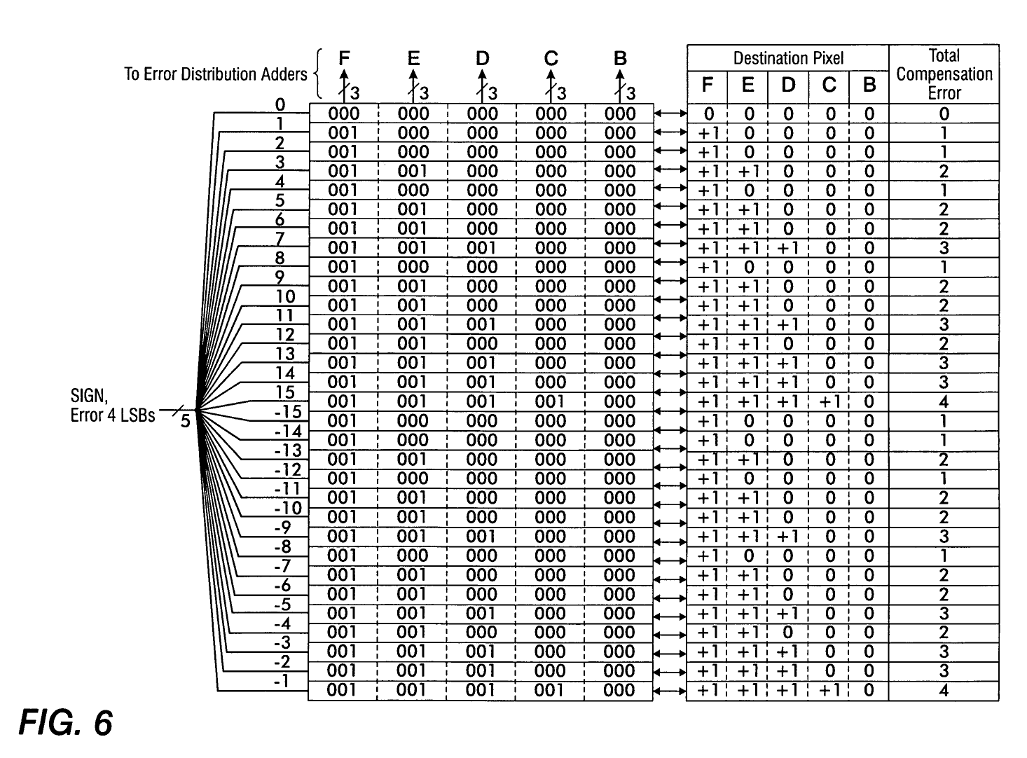

FIG. 6 depicts an exemplary look-up table with values according to an embodiment. The LUT 505 may be used to distribute and compensate for truncation error. Since the LUT 505 is programmable, additional embodiments including different values for each location may be used. In an embodiment, the LUT 505 may compensate for the truncation error shown caused by bit-shifting using the Shiau-Fan error diffusion coefficients as recorded in the total truncated error component 430 of FIG. 4.

In an embodiment using the error compensation values shown in FIG. 6, the 31×15 LUT may be replaced with a 31×4 LUT where a single bit may be mapped to each of destination pixel C 422, destination pixel D 423, destination pixel E 424, and destination pixel F 425 because all other bits may always be assigned a value of ‘0’. In an alternate embodiment using the error compensation values shown in FIG. 6, the 31×15 LUT 505 may be replaced with a 16×4 LUT since the value of the sign bit for the error value does not affect the error compensation values of the LUT. In such an embodiment, the sign bit 411 may not be used as an index/address to the LUT 505.

In the case of a color imaging system, a plurality of implementations of the described method and system or a similar error diffusion method and system may be used. For example, a first implementation may determine whether a pixel includes the color cyan or the color white; a second implementation may determine whether a pixel includes the color magenta or the color white; a third implementation may determine whether a pixel includes the color yellow or the color white; and a fourth implementation may determine whether a pixel includes the color black or the color white. Error values for each of the cyan, magenta, yellow and black implementations may be diffused to subsequent pixels. Additional or alternate implementations, such as red, green, blue and black, may also be used within the scope of this disclosure.

In an embodiment, a xerographic apparatus, such as a digital scanner, facsimile device, copying device, a multifunctional device, and the like may include the methods and systems described above. Other non-xerographic apparatuses performing similar functions may also include methods and systems within the scope of the present disclosure.

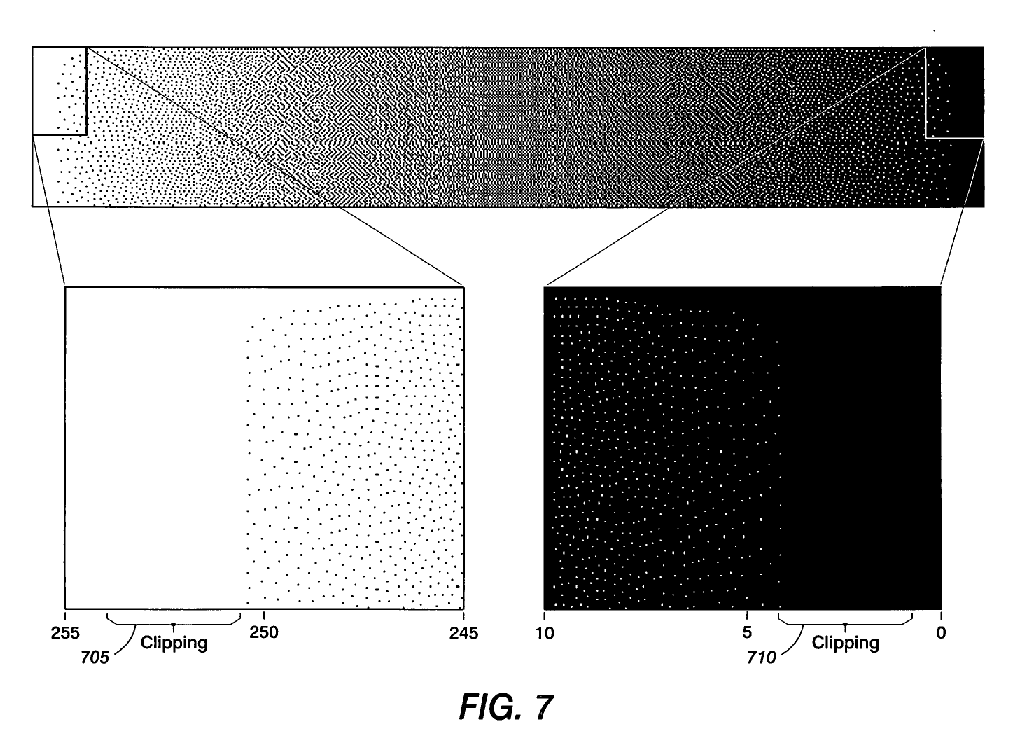

FIG. 7 depicts an exemplary grayscale sweep for which no divisional bit-shifting truncation error compensation is performed. As shown in FIG. 7, at the extreme highlight 705 and shadow 710 regions, the gray levels are “clipped.” Although the number of gray levels clipped is relatively small, these levels may have a great benefit toward producing pleasing high-quality grayscale prints. This may particularly be the case when rendering graphics and/or homogeneous regions with uniform background intensities.

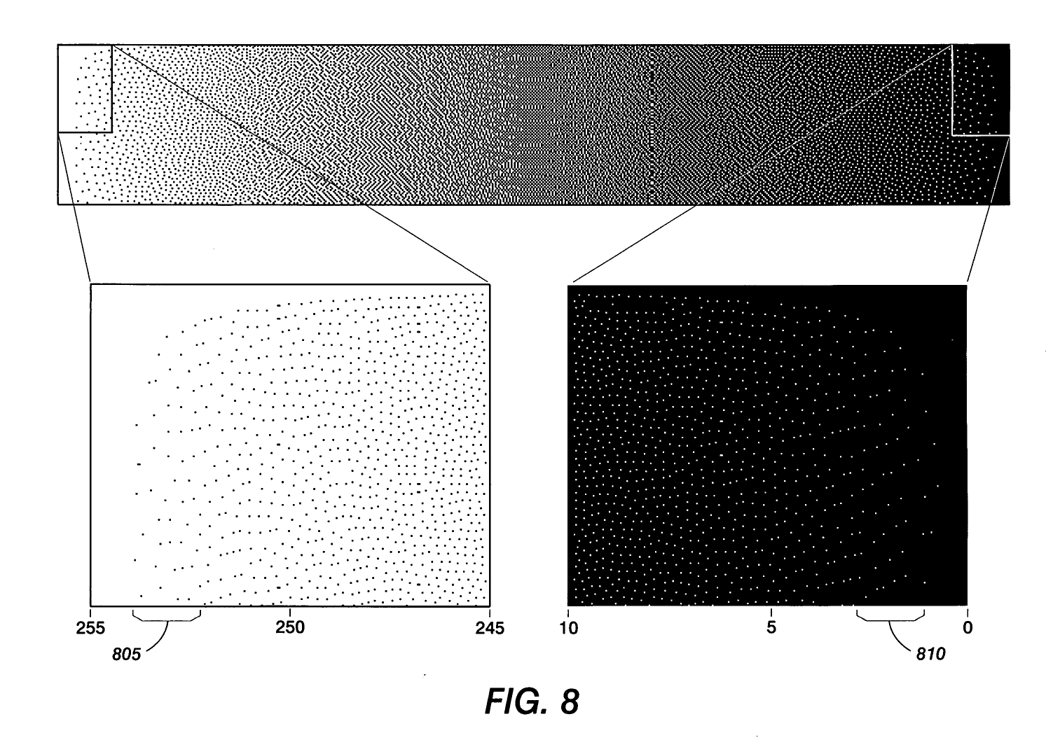

FIG. 8 depicts an exemplary grayscale sweep for which divisional bit-shifting truncation error compensation is performed according to an embodiment. As shown in FIG. 8, the error compensation process may prevent clipping at the extreme highlight 805 and shadow 810 regions. As such, improved image quality may result.

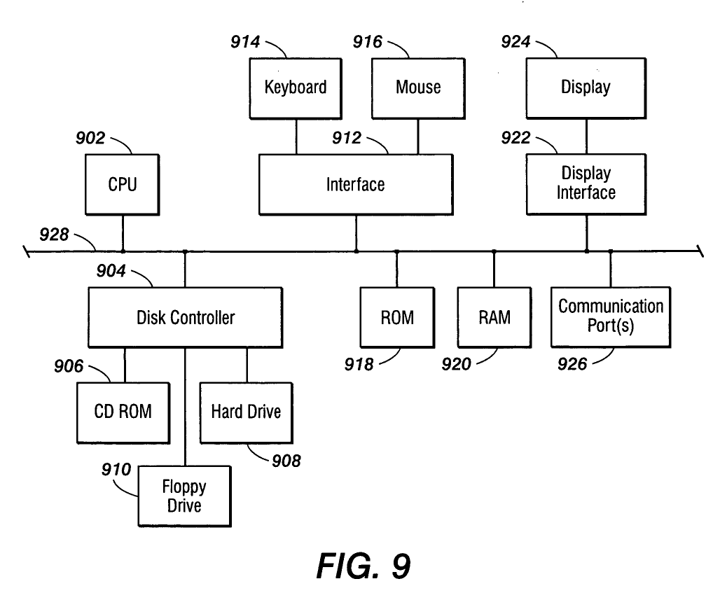

FIG. 9 is a block diagram of exemplary internal hardware that may be used to contain or implement the program instructions according to an embodiment. Referring to FIG. 9, a bus 928 may serve as a main information highway interconnecting the other illustrated components of the hardware. CPU 902 is the central processing unit of the system, performing calculations and logic operations required to execute a program. Read only memory (ROM) 918 and random access memory (RAM) 920 constitute exemplary memory devices.

A disk controller 904 interfaces with one or more optional disk drives to the system bus 928. These disk drives may be external or internal floppy disk drives such as 910, CD ROM drives 906, or external or internal hard drives 908. As indicated previously, these various disk drives and disk controllers are optional devices.

Program instructions may be stored in the ROM 918 and/or the RAM 920. Optionally, program instructions may be stored on a computer readable medium such as a floppy disk or a digital disk or other recording medium, a communications signal or a carrier wave.

An optional display interface 922 may permit information from the bus 928 to be displayed on the display 924 in audio, graphic or alphanumeric format. Communication with external devices may optionally occur using various communication ports 926. An exemplary communication port 926 may be attached to a communications network, such as the Internet or an intranet.

In addition to computer-type components and their equivalents, the hardware may also include an interface 912 which allows for receipt of data from input devices such as a keyboard 914 or other input device 916 such as a remote control, pointer and/or joystick.

A multiprocessor system may optionally be used to perform one, some or all of the operations described herein. Likewise, an embedded system, such as a sub-system within a xerographic apparatus, may optionally be used to perform one, some or all of the operations described herein.

For example, a xerographic apparatus may scan an image into, download an image in or otherwise receive an image in, for example, a digital format. The digital format may include one or more pixel values for each pixel in the image. The pixel values may be stored in a memory prior to processing or may be utilized for processing as the image is being scanned. The xerographic apparatus may use a method described above or an equivalent method to determine binary pixel values, error diffusion values and error compensation values as each pixel is processed. Error information may be forwarded to the destination pixels. Upon completion of or during pixel processing, the resulting binary image may be transferred to, for example, a printing module of the xerographic apparatus, a printer, or any other device for generating a human-readable representation of the image.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for performing error diffusion, the method comprising:
receiving an error value for a pixel;
determining one or more error diffusion values based on the error value;
compensating for a difference between the error value and a sum of the error diffusion values by summing each error diffusion value with a corresponding error compensation value to yield one or more compensated error diffusion values; and
diffusing a compensated error diffusion value to a destination pixel.

2. The method of claim 1 wherein determining one or more error diffusion values comprises bit shifting the error value.

3. The method of claim 1 wherein:
compensating for the difference between the error value and a sum of the error diffusion values further comprises determining the difference between the error value and the sum of the error diffusion values; and
when summing each error diffusion value with the corresponding error compensation value, a sum of the error compensation values is equal to the difference between the error value and the sum of the error diffusion values.

4. The method of claim 3 wherein determining the difference between the error value and a sum of the error diffusion values comprises accessing a lookup table.

5. The method of claim 4 wherein the lookup table is accessed using an address based at least in part on one or more bits of the error value.

6. The method of claim 4 wherein the lookup table is accessed using an address based at least in part on a sign bit of the error value.

7. The method of claim 4 wherein the lookup table is programmable.

8. The method of claim 1 wherein diffusing the compensated error diffusion value comprises adding the compensated error diffusion value for the destination pixel to an error value for the destination pixel.

9. The method of claim 1 wherein each error value pertains to an error in coloration for the corresponding pixel of one or more of the following:
one of cyan and white;
one of magenta and white;
one of yellow and white; and
one of black and white.

10. A system for performing error diffusion, the system comprising:
a processor; and
a processor-readable storage medium in communication with the processor,
wherein the processor-readable storage medium contains one or more programming instructions for performing a method for performing error diffusion, the method comprising:
receiving an error value for a pixel from a memory location in the processor-readable storage medium pertaining to the pixel,
determining, via the processor, one or more error diffusion values based on the error value,
compensating, via the processor, for a difference between the error value and a sum of the error diffusion values by summing each error diffusion value with a corresponding error compensation value to yield one or more compensated error diffusion values, and
diffusing a compensated error diffusion value to a memory location in the processor-readable storage medium pertaining to a destination pixel.

11. The system of claim 10 wherein determining one or more error diffusion values comprises one or more programming instructions for bit shifting, via the processor, the error value.

12. The system of claim 10 wherein:
compensating for the difference between the error value and a sum of the error diffusion values comprises determining the difference between the error value and the sum of the error diffusion values; and
when summing each error diffusion value with the corresponding error compensation value, a sum of the error compensation values is equal to the difference between the error value and the sum of the error diffusion values.

13. The system of claim 12 wherein determining the difference between the error value and a sum of the error diffusion values comprises one or more programming instructions for accessing a lookup table.

14. The system of claim 13 wherein the lookup table is accessed using an address based at least in part on one or more bits of the error value.

15. The system of claim 13 wherein the lookup table is accessed using an address based at least in part on a sign bit of the error value.

16. The system of claim 13 wherein the lookup table is programmable.

17. The system of claim 10 wherein diffusing the compensated error diffusion value comprises adding the compensated error diffusion value for the destination pixel to an error value for the destination pixel.

18. The system of claim 10 wherein each error value pertains to an error in coloration for the corresponding pixel of one or more of the following:
one of cyan and white;
one of magenta and white;
one of yellow and white; and
one of black and white.

19. A method for producing an output image by performing error diffusion, the method comprising:
receiving an input image, wherein the input image comprises a plurality of pixels;
determining a pixel intensity value for each pixel;
for each pixel:
receiving an initial error value,
calculating a pixel value for the pixel and an updated error value, wherein each of the pixel value and the updated error value are computed based on the pixel intensity value for the pixel and the initial error value,
determining one or more error diffusion values based on the updated error value,
compensating for a difference between the updated error value and a sum of the error diffusion values by summing each error diffusion value with a corresponding error compensation value to yield a compensated error diffusion value, and
diffusing a compensated error diffusion value to an initial error value for a destination pixel; and
generating an output image based on the pixel values.

20. The method of claim 19 wherein:
compensating for the difference between the updated error value and a sum of the error diffusion values further comprises determining the difference between the updated error value and the sum of the error diffusion values; and
when summing each error diffusion value with the corresponding error compensation value, a sum of the error compensation values is equal to the difference between the updated error value and the sum of the error diffusion values.
